(19) United States
(12) Patent Application Publication
(10) Pub. No.: US 2026/0326896 A1
(43) Pub. Date: Oct. 22, 2026

(54) Passive Blade-Vortex Interaction Noise Reduction Strategy Using In-Blade Resonator Cavities

(71) Applicant: The Penn State Research Foundation, Univesity Park, PA (US)

(72) Inventors: Daniel Weitsman, University Park, PA (US); Eric Greenwood, University Park, PA (US)

(73) Assignee: The Penn State Research Foundation, Univesity Park, PA (US)

(21) Appl. No.: 19/484,713

(22) PCT Filed: May 23, 2024
(86) PCT No.: PCT/US2024/030742

§ 371 Date: Nov. 14, 2025

Related U.S. Application Data
(60) Provisional application No. 63/504,022, filed on May 24, 2023.

(51) Int. Cl. B64C 27/473

(52) U.S. Cl. CPC B64C 27/473; B64C 2230/14; B64C 2230/24; B64C 2230/28

(57) ABSTRACT

Embodiments relate to a rotorcraft blade including a body having a top surface, a length, a width, and a thickness, wherein the body of the rotor blade comprises a plurality of resonator cavities positioned in the top surface to extend from the top surface to within the thickness of the body. Each of the resonator cavities are sized and configured to extend from the top surface to within the body for reducing a noise caused via rotation of the at least one rotor blade.

### CROSS-REFERENCE TO RELATED APPLICATIONS

This patent application is related to and claims the benefit of priority of U.S. Provisional Application 63/504,022, filed on May 24, 2023, the entire contents of which is incorporated by reference.

### FIELD

The present disclosure generally relates to a rotor blade including embedded resonator cavities configured to reduce rotorcraft noise, such as blade vortex interaction noise, and methods of using thereof.

### BACKGROUND

Blade vortex interaction (BVI) noise is one of the most distinctive qualities of a rotorcraft's overall noise emissions and contributes significantly to community annoyance. It is typically generated in descending flight conditions, which is when the rotorcraft tends to be near the ground. Due to their loud noise emissions, the operations of rotorcraft are already highly restricted in densely populated areas and there is constantly new legislation being proposed to further extend these restrictions. Therefore, reducing BVI noise would reduce community annoyance, which would promote public acceptance of rotorcraft and in turn be profitable for vehicle operators and manufacturers.

### SUMMARY

Previous strategies to address BVI noise have been limited to significantly altering the geometry of the rotor blade. However, such modifications can cause the blade to become prone to structural issues and/or aeroelastic instabilities. There is a demanding need to design a BVI noise reduction strategy that does not alter the geometry of the rotor blade itself.

Accordingly, a passive BVI noise reduction strategy has been developed. We have found that BVI noise can be attenuated substantially by embedding hollow resonator cavities inside of the rotor blades. These resonator cavities can alter the blade surface pressures and the associated kinematics of BVI noise. This strategy successfully circumvents the above-mentioned shortcomings of previously purposed BVI noise reduction strategies since the overall blade geometry remains unaltered.

More specifically, the cavities can have uniform or variable lengths and may be positioned at various spanwise locations along the span of the blade. For example, it was found that significant global reduction in BVI noise can be obtained by applying variable length cavity patches along the frontal portion of the blade, near the leading edge, as this region is typically hollow or filled with a soft foam-like material. Alternatively, reduction in BVI noise can also be obtained by varying the spanwise distribution of uniform length cavity patches. These approaches may delay and reduce the magnitude of the blade load fluctuations attributed to BVI. The variable length resonator patches can significantly redistribute the energy associated with the BVI azimuthally about the rotor hub/disk, while the staggered uniform length patches can introduce the precise amount of phase delay required to prevent the acoustic waves due to a BVI event from coalescing. Recent advent of advanced additive manufacturing techniques makes it possible to fabricate complex resonator cavity lengths and geometries and to achieve these objectives.

In an exemplary embodiment, a rotorcraft blade comprises a body having a top surface, a length, a width, and a thickness. The body may comprise a plurality of resonator cavities positioned in the top surface to extend from the top surface to within the thickness of the body. Each of the resonator cavities may be sized and configured to extend from the top surface to within the body for reducing a noise caused via rotation of the at least one rotor blade.

In some embodiments, a distal region of the rotor blade comprises a first grouping of the resonator cavities as a first patch of the resonator cavities.

In some embodiments, a proximal region of the rotor blade comprises a second grouping of the resonator cavities as a second patch of the resonator cavities.

In some embodiments, the plurality of cavities are configured to attenuate blade vortex interaction noise by at least 6 decibels.

In some embodiments, each cavity has a radius and a length, wherein the radius is less than the shortest acoustic wavelength of interest, which can be a pre-selected acoustic wavelength that is shorter than a pre-selected maximum acoustic wavelength.

In some embodiments, at least one of the resonator cavities is bent such that the cavity extends in a width direction of the rotor blade within a thickness of the rotor blade. The width direction can be a direction that extends along a width of the blade. The width of the blade can extend perpendicular to the length of the blade and can also extend perpendicular to the thickness of the blade.

In some embodiments, the resonator cavities are arranged in spaced apart patches of resonator cavities along the length of the blade.

In some embodiments, the blade further comprises a facesheet covering the resonator cavities.

In some embodiments, the resonator cavities have different lengths or have uniform lengths.

In some embodiments, some of the resonator cavities have different lengths.

In some embodiments, the resonator cavities have between 2 and 50 unique lengths.

In some embodiments, the resonator cavities are distributed in one or more patches positioned at an outermost 25% of the rotor blade adjacent to a leading edge of the body.

In some embodiments, the outermost 25% of the rotor blade has an open area ratio of 0.6.

In some embodiments, the resonator cavities are configured to attenuate blade vortex interaction noise by at least 8 decibels.

In some embodiments, each of the resonator cavities has a radius and a length, and wherein at least some of the resonator cavities are bent to extend within the body along a portion of the width of the body.

In an exemplary embodiment, a rotorcraft comprises a rotatable hub connected to a blade. The blade comprises a body having a top surface, a length, a width, and a thickness. The body may comprise a plurality of resonator cavities positioned in the top surface to extend from the top surface to within the thickness of the body. Each of the resonator cavities may be sized and configured to extend from the top surface to within the body for reducing a noise caused via rotation of the at least one rotor blade.

In an exemplary embodiment, a process for reducing noise associated with rotation of one or more rotor blades comprises providing one or more blades, each blade having a plurality of resonator cavities; rotating the one or more blades to cause a device to move such that fluid is passed through the resonator cavities during rotation of the one or more blades, the fluid being passed through the resonator cavities to provide at least one phase shift of sound to reduce noise generated via rotation of the one or more blades.

In some embodiments, the device is a helicopter or a drone.

In some embodiments, the process further comprises defining the resonator cavities in the blade to extend from a top surface of the blade to within a thickness of the blade.

In some embodiments, the resonator cavities are defined to have a uniform length.

In some embodiments, the resonator cavities are defined so at least some of the resonator cavities have different lengths.

### BRIEF DESCRIPTION OF THE DRAWINGS

The above and other objects, aspects, features, advantages, and possible applications of embodiments of the present innovation will be more apparent from the following more particular description thereof, presented in conjunction with the following drawings. Like reference numbers used in the drawings may identify like components.

FIG. 1 is a schematic illustration of an exemplary embodiment of a rotor blade utilizing various cavity patches to effectively attenuate BVI noise.

FIG. 2 is a cross-section view of an exemplary embodiment of a rotor blade utilizing various cavity patches to effectively attenuate BVI noise.

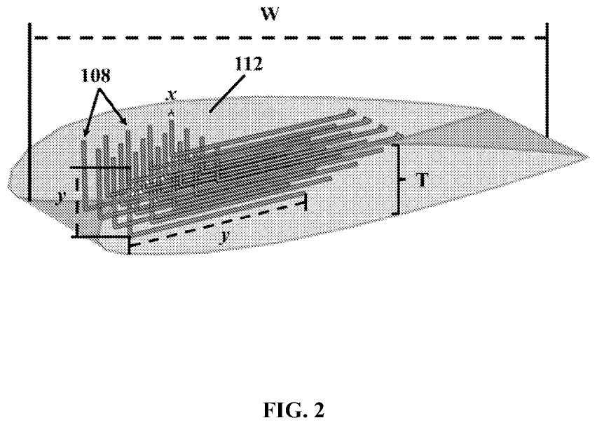

FIG. 3 is a contour graph showing a comparison between predicted and measured acoustic emissions of the scaled Bo105 rotor operating at a baseline descent condition.

FIG. 4 is a graph showing optimal cavity geometry distribution comprising each variable length cavity patch.

FIG. 5 is a graph showing resistive and reactance components of the normal acoustic impedance along with the absorption of a uniform length cavity patch.

FIG. 6 is a graph showing resistive and reactance components of the normal acoustic impedance along with the absorption of a variable length cavity patch.

FIG. 7 is a plot showing time rate of change in the lift component of the blade loads for the baseline case.

FIG. 8 is a plot showing time rate of change in the lift component of the blade loads for the uniform length cavity patch embodiment.

FIG. 9 is a plot showing time rate of change in the lift component of the blade loads for the variable length cavity patch embodiment.

FIG. 10 is a contour graph showing comparison between the predicted acoustic emissions corresponding to the baseline rotor blades and those treated with the uniform length cavity patch embodiment.

FIG. 11 is a contour graph showing comparison between the predicted acoustic emissions corresponding to the baseline rotor blades and those treated with the variable length cavity patch embodiment.

FIG. 12 is a graph showing resistive and reactance components of the normal acoustic impedance along with the absorption of a uniform length cavity patch.

FIG. 13 is a graph showing the spanwise distribution of cavities in the uniform length cavity patch embodiment.

FIG. 14 is a plot showing time rate of change in the lift component of the blade loads for the baseline case.

FIG. 15 is a plot showing time rate of change in the lift component of the blade loads for the uniform length cavity patch embodiment.

FIG. 16 is a contour graph showing comparison between the predicted acoustic emissions corresponding to the baseline rotor blades and those treated with the uniform length cavity patch embodiment.

FIG. 17 is a plot showing time rate of change in the lift component of the blade loads for the baseline case.

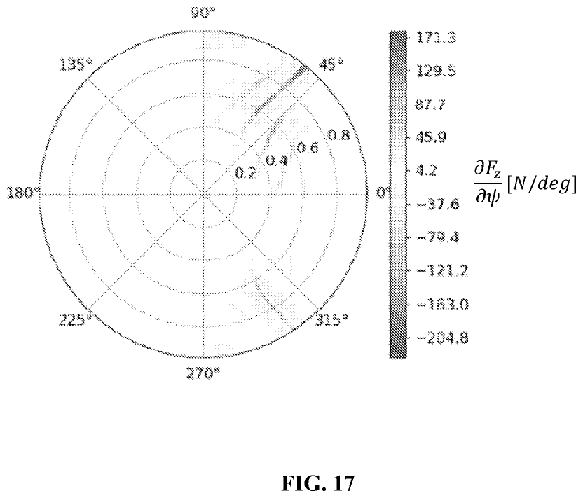

FIG. 18 is a plot showing time rate of change in the lift component of the blade loads for the variable length cavity patch embodiment.

FIG. 19 is a contour graph showing comparison between the predicted acoustic emissions corresponding to the baseline rotor blades and those treated with the variable length cavity patch embodiment.

FIG. 20 is a contour graph showing comparison between the predicted acoustic emissions corresponding to the baseline rotor blades and those treated with the variable length cavity patch embodiment.

### DETAILED DESCRIPTION

The following description is of exemplary embodiments and methods of use that are presently contemplated for carrying out the present invention. This description is not to be taken in a limiting sense but is made merely for the purpose of describing the general principles and features of various aspects of the present invention. The scope of the present invention is not limited by this description.

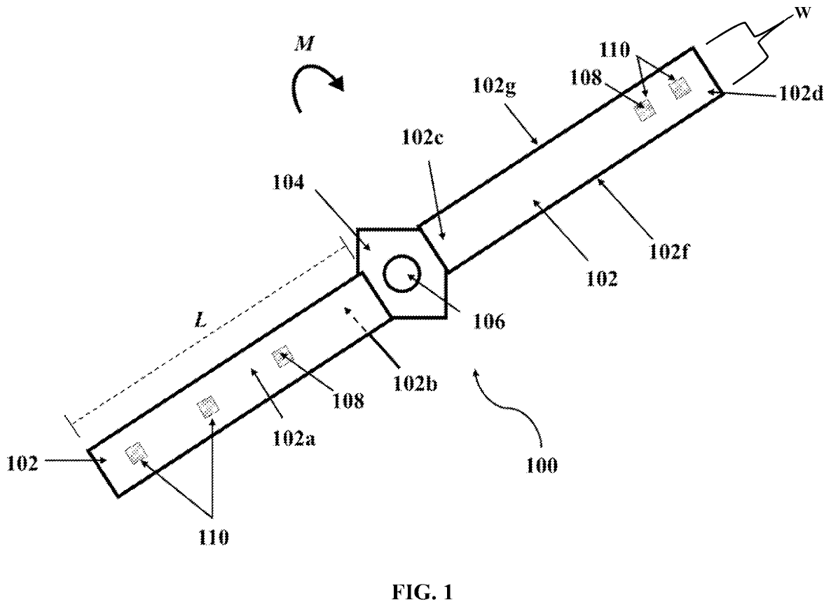

Referring to FIG. 1, a rotorcraft 100, such as a helicopter, can be configured as a vehicle with at least one rotor blade 102 extending from a rotor disk 104 (e.g., rotor hub) and configured to generate lift by rotating about a shaft 106. The disk 104 is typically configured to hold the blade 102 in a proper position for aerodynamic efficiency and indirectly couple the blade 102 to the shaft 106. A motor or engine can be coupled to the rotor disc 104 to drive rotation of the disk 104 via the shaft 106, for example. A plurality of blades 102 extending from the disk 104 may collectively be referred to as a “rotor.”

The rotor blade 102 can have an elongated body that has a top surface 102a and a bottom surface 102b opposite the top surface 102a. In embodiments in which the rotor blade 102 is for use in helicopters or other configurations in which the rotational axis of the rotor extends vertically, the bottom surface 102b can be configured to be a ground-facing surface when the rotorcraft 100 is in operation. In embodiments in which the rotor blade 102 may be utilized in airplanes or other configurations in which the rotational axis of the rotor blade 102 extends horizontally, the bottom surface 102b can be a back surface of the blade 102 and the top surface can be a forward surface of the blade 102.

The body of the rotor blade 102 has a length L (e.g., span), a width W, and a thickness T. The thickness T may vary across the width W of the blade 102. The width W can extend in a width direction. The length L can extend in a length direction. The thickness T can extend in a thickness direction. the width direction can be perpendicular to the length direction and the thickness direction.

The length L can extend from its first end at a proximal region 102c to a second end that can be positioned at a distal region 102d. As used herein, the term “proximal” refers to the region of the blade 102 that can be positioned closer to the disk 104, while the term “distal” refers to the region of the blade 102 that can be located farther from the disk 104. It is contemplated that the body of the blade 102 has a leading edge side 102f and a trailing edge side 102g, wherein the leading edge side 102f includes a leading edge of the blade 102 and the trailing edge side 102g includes a trailing edge of the blade 102 when the blade 102 is moving in rotational direction M during operation (e.g. clockwise or counterclockwise). The leading edge side 102f and the trailing edge side 102g can extend on opposite sides of the body of the rotor blade between the first end of the body and the second end of the body. The top surface 102a and the bottom surface 102b can be on opposite sides of the body of the blade 102 and extend between the leading edge side 102f and the trailing edge side 102g and also extend between the first end and the second end of the body of the blade 102.

The distance between the leading edge of the leading edge side 102f and the trailing edge of the trailing edge side 102g can define a width W of the blade 102 (e.g. a width W of the body of the blade 102). The thickness T of the body of the blade 102 may be uniform or may vary along the width W of the blade 102 (e.g. the blade 102 may taper from its leading edge side 102f to its trailing edge side 102g in some embodiments such that the trailing edge side 102g is thinner than its leading edge side 102f or the blade 102 may taper from its trailing edge side 102g to its leading edge side 102f such that the leading edge is thinner than its trailing edge side 120g).

The generation of BVI noise can be significant when a rotorcraft is operating in descending or maneuvering flight. To help reduce such noise, we have found that the rotor blade 102 can including a plurality of resonator cavities 108 embedded in the top surface 102a of the blade 102. In preferred embodiments, the cavities 108 are exposed at the top surface 102a but are not exposed at the bottom surface 102b, such that the cavities 108 do not extend through the blade 102. Each resonator cavity 108 can be a passageway that extends from a resonator cavity inlet defined in the top surface 102a to an interior location within a thickness T of the blade 102, for example.

The plurality of resonator cavities 108 can be configured to attenuate BVI noise created by the rotorcraft 100, for example, by altering the surface pressures of the blade 102 and the associated kinematics of the BVI noise. The resonator cavities 108 can be positioned and configured in the blade 102 to introduce a phase delay and reduce the magnitude of the blade surface pressure fluctuations attributed to BVI when the blade 102 is rotated, which may prevent the acoustic wavefronts of the BVI noise sources from constructively summing together and coalescing. In particular, the phase delay that can help prevent the acoustic waves from coalescing may be introduced by the time that it takes the blade surface pressure fluctuations to propagate into and out from a cavity 108. Accordingly, it is contemplated that the amount of time delay that is introduced to the blade 102 related to the length y of the cavity 108. Utilizing the plurality of cavities 108 to attenuate BVI noise is an advantageous strategy as it can be employed without altering the overall geometry of the blade 102.

In some embodiments, the lengths y of the resonator cavities 108 can be a uniform length and the resonator cavities 108 can be positioned at different discrete regions along the length L of the blade 102. In other embodiments, the resonator cavities 108 can be provided along a length L of the blade 102 and can have variable lengths to provide a pre-selected set of phase delays for reducing the noise that may be created from rotation of the blade 102. In yet another embodiment, the variable length resonator cavities can be applied to discrete regions along the length L of the blade 102 to achieve a further noise reduction.

It is contemplated that the cavities 108 may be configured to attenuate BVI noise by at least 6 decibels or by at least 8 decibels in some embodiments.

Each cavity 108 may have a radius x and a length y. The length y of the resonator cavity 108 can extend from an inlet or mouth of the resonator cavity 108 defined in the top surface to a terminal end positioned within the body or the rotor blade 102 inside the thickness T of the rotor blade 102. In some embodiments, the radius x of each cavity 108 should be less than the shortest acoustic wavelength of interest. The shortest acoustic wavelength of interest can be a pre-selected acoustic wavelength that can be utilized to help determine resonator sizing and/or configuration. In other situations, manufacturing tolerances may be utilized for selecting sizing instead of (or in addition to) the selection of a shortest acoustic wavelength of interest.

For instance, if the maximum frequency of interest is 3000 Hz (wavelength of 113 mm), which is generally the upper limit of the frequency range where BVI noise tends to be most prominent, the maximum radius x of cavity 108 would be 18 mm. It is contemplated that the minimum radius x is set by manufacturing tolerances and/or by a selected shortest acoustic wavelength of interest. The length y of each cavity 108 determines the duration by which the blade load fluctuations are delayed. To be effective, the length y of each cavity 108 may be on the order of one to two chord lengths W.

It is contemplated that the cavities 108 may be any shape or geometry. For example, in some embodiments, at least one cavity 108 may extend in a vertical or substantially vertical direction (e.g., a straight conduit) within the blade 102. In some embodiments, at least one cavity 108 may be bent (e.g., an elbow-shaped conduit) such that it extends both in a vertical direction and in the length direction within the blade 102. It is contemplated that bending a cavity 108 within the blade 102 allows for the length y of the cavity 108 to increase, thereby introducing a greater phase delay. It is contemplated that a blade 102 may include cavities 108 of different geometries such that at least one cavity 108 may be a straight conduit and at least one cavity 108 may be an elbow-shaped conduit.

In yet other embodiments, each resonator cavity can be coiled or have one or more bends. The length y of the resonator cavity can be a length along with air may travel through the cavity to the cavity's terminal end within the blade 102. The radius x of the cavity 108 can be a distance that is a half of the width of the resonator cavity (e.g. half of a diameter of the resonator cavity 108).

The rotor blade 102 may have at least one patch 110 including a plurality of cavities 108. As used herein, the term “patch” can refer to an area or region of the blade 102 having an array or grouping of cavities in close proximity to one another. It is contemplated that each patch 110 may include any number of cavities 108, such as between 2-200 cavities. The number of cavities 108 in each patch 110 is not particularly limited but does depend on the diameter of each cavity 108 and the size of each patch 110. It is further contemplated that each patch 110 may include the same number of cavities 108 or a different number of cavities 108.

In one embodiment, the rotor blade 102 may have a plurality of patches 110 wherein each cavity 108 of each patch 110 may have a uniform length y. For example, each cavity 108 embedded in the blade 102 may have the same length y. The patches 110 may be distributed at various positions along the length L of the blade 102. For example, the proximal region 102c may include one or more patches 110, the distal region 102d may include one or more patches 110, the frontside 102f may include one or more patches 110, and/or the backside 102g may include one or more patches 110. It is contemplated that patches 110 distributed at the distal region 102d of the blade 102 may be preferable, as this is where the local velocities are highest and, therefore, the blade load fluctuations in the distal region 102d have the greatest influence on the resulting noise emissions. It may also be preferable to position the patches 110 closer to the leading edge 102f and on the upper surface of the blade 102a as this is where the surface pressures tend to be greatest. Accordingly, cavities 108 positioned in this region may have little to no effect on blade 102 performance.

As mentioned above, it is contemplated that the cavities 108 are configured to introduce a phase delay to attenuate BVI noise. In particular, cavities 108 of uniform length y can be distributed at various discrete positions along the length L of the blade 102 to introduce a precise amount of phase delay to prevent the acoustic waves generated by BVI events from adding constructively and coalescing as they propagate to the acoustic far field.

In another embodiment, the rotor blade 102 may have a plurality of patches 110 wherein each cavity 108 embedded in the blade 102 may not have a uniform length y. For example, the cavities 108 may have a plurality of unique lengths y. It is contemplated that the cavities 108 may include any number of unique lengths y, such as between 2-50 unique lengths. The number of unique lengths is not particularly limited as long as all the cavities 108 comprising the patch 110 are able to fit within the patch, while maintain a predefined open area ratio. The open area ratio represents the portion of the patch 110 that is occupied by the inlets of all the cavities 108. A reasonable open area ratio may be approximately 0.6. In this embodiment, it is preferred that the patches 110 may be distributed in the distal region 102d of the blade 102. Accordingly, cavities 108 positioned in this region may have little to no effect on blade 102 performance. Preferably the patches 110 may be distributed in the outermost 50% of the blade 102, more preferably in the outermost 25% of the blade 102.

Cavities 108 of unique lengths y may introduce a phase delay to attenuate BVI noise by significantly redistributing the energy associated with the blade load fluctuations due to BVI events azimuthally about the rotor disk. Accordingly, a more broadband absorption response may be achieved.

It is contemplated that the blade 102 may include a facesheet 112. The facesheet 112 may cover the cavities 108 and be configured to minimize additional viscous drag generated by these cavities 108. The facesheet 112 will increase viscous dissipation effects and likely further reduce the strength of the blade load fluctuations due to BVI events.

In some embodiments, each rotor blade 102 can have a body that includes the resonator cavities 108 on the top surface 102a of the body. There can be a plurality of spaced apart patches 110 of the resonator cavities 108 that can include a first patch adjacent a distal edge of the body, a second patch, and a third patch. The second patch can be positioned between the first patch and the third patch along a length L of the body of the rotor blade. Each patch 110 can have a number of resonator cavities that have variable lengths so that at least some of the resonator cavities have unique lengths as compared to other resonator cavities within the patch 110. Each patch 110 can include the same grouping of different length resonator cavities 108 or may have a different arrangement of different length resonator cavities 108. In yet other embodiments, each patch 110 can have uniform length resonator cavities 108. Those uniform lengths can be different from the lengths of other patches 110 or can be the same length as other patches 110. If a patch 110 is comprised of variable length resonator cavities 108 it may be preferable to avoid positioning cavities of equal lengths adjacent to one another.

In an exemplary embodiment, a first patch may have any number of resonator cavities, wherein the lengths of these cavities may be the same or different. For example, if the first patch has at least ten cavities, the first and tenth cavities may have a first length, the second and ninth cavities may have a second length, the third and eight cavities may have a third length, the fourth and seventh cavities may have a fourth length, and the fifth and sixth cavities may have a fifth length, such that the first, second, third, fourth, and fifth lengths of the first patch may be the same or different from one another. Further, a second patch may have any number of resonator cavities, wherein the lengths of these cavities may be the same or different. For example, if the second patch has at least ten cavities, the first and tenth cavities may have a first length, the second and ninth cavities may have a second length, the third and eight cavities may have a third length, the fourth and seventh cavities may have a fourth length, and the fifth and sixth cavities may have a fifth length, such that the first, second, third, fourth, and fifth lengths of the second patch may be the same or different from one another. Even further, a third patch may have any number of resonator cavities, wherein the lengths of these cavities may be the same or different. For example, if the third patch has at least ten cavities, the first and tenth cavities may have a first length, the second and ninth cavities may have a second length, the third and eight cavities may have a third length, the fourth and seventh cavities may have a fourth length, and the fifth and sixth cavities may have a fifth length, such that the first, second, third, fourth, and fifth lengths of the third patch may be the same or different from one another.

The rotor blade 102 as described herein may be used in any rotorcraft, such as helicopters, autogyros, gyrodones, remote controlled rotorcraft (e.g., drones), etc. The rotor blade 102 may further be used in other vehicles, such as airplanes, submarines, boats having at least one impeller that includes the rotor blade 102, etc.

### EXAMPLES

We conducted simulation work in order to evaluate the effectiveness of the disclosed noise reduction strategy that can be utilized in embodiments of our rotor blade 102. The dynamic wake code OpenCOPTER was employed to model BVI events. The blade loads predicted by OpenCOPTER were then filtered in accordance with the acoustic impedance of the resonator cavities, which are modeled using the semi-analytical Zwikker-Kosten Transmission Line (ZKTL) model. The acoustic propagator code PSU-WOPWOP was then used to predict the corresponding noise emissions. PSU-WOPWOP employs Farassat's Formulation 1A, which is the integral representation of the solutions of the governing Ffowcs-Williams and Hawkings (FW-H) equation to determine the near and far-field acoustic emissions.

The Higher Harmonic Control Aeroacoustic Rotor Test (HART II) was chosen as the reference dataset for this analysis. As part of this joint test campaign, a 40% Mach scaled Bo105 hingeless rotor was tested in the Large Low-speed Facility of the German-Dutch Wind Tunnel (DNW) in the Netherlands. The comprehensive dataset included measurements of the rotor loads, blade surface pressures and deformation, as well as the acoustic emissions. Acoustic measurements were acquired with a traversable array consisting of thirteen microphones that was positioned 1.075 rotor radii below the rotor plane.

The maximum BVI noise radiation test point (C_{T}=0.0046, μ=0.151, αₛ=5.3°, Ω=1040 RPM) was selected as the nominal operating condition. The Higher Harmonic Control (HHC) system was disabled for the baseline case. Since the optimal geometry and spanwise distribution of the resonators was not known, a global optimizer was wrapped around the computational framework to determine the optimal configuration for attenuating BVI noise.

### Blade Loading Prediction

The dynamic wake code OpenCOPTER was used to resolve the rotor wake geometry and, therefore, the BVI events. This method is unique in that it employs a dynamic inflow model that is derived from potential flow theory to compute the velocity at any point in the flow field. This dynamic inflow model informs the convection of the shed wake and deforms it accordingly. The advantage of this wake model is that it has improved accuracy over prescribed wake methods but at a fraction of the computational cost of free-wake methods.

It should be noted that this approach predicts the chordwise compact blade loads, whereby, the integrated blade loads are prescribed at the quarter-chord of the airfoil. Furthermore, the sectional lift and drag coefficients were estimated using the AERODAS model. This model predicts the pre and post stall behavior of an airfoil based on several basic parameters, such as its minimum and maximum lift and drag coefficients. Unsteady aerodynamics effects are captured using a high resolution model of the spanwise shed wake until the trailed vorticity rolls up at a wake age of 30 degrees. The blades were assumed to be rigid, and their flapping motion is prescribed directly from the measurements.

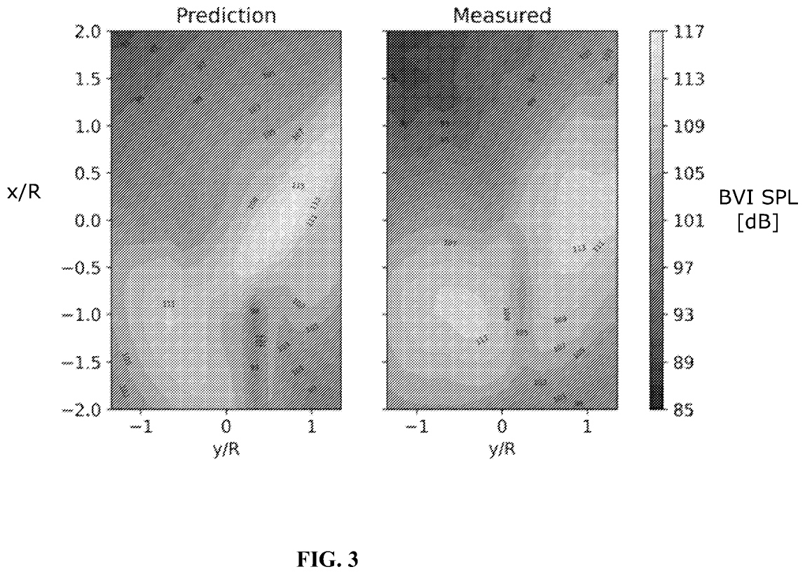

FIG. 3 presents a comparison between the predicted and measured acoustic emissions of the scaled Bo105 rotor operating at the baseline descent condition. The contours display the BVI sound pressure level (SPL) corresponding to frequencies ranging from the 6th to 40th harmonic of the blade passage frequency (BPF), which is the frequency range in which the majority of acoustic energy associated with BVI noise resides. This prediction framework is able to adequately resolve the two hotspots on the advancing and retreating sides of the rotor disk, which are consistent with the directivity of BVI noise. This suggests that the kinematics of oblique and parallel BVI events are captured. The SPL in the hotspot on the right-hand side of FIG. 3, below the advancing side of the rotor disk, is overpredicted by 2 dB. Since this prediction framework was able to resolve the directionality of BVI noise it is deemed to be adequate for this example.

### Resonator Impedance Modeling

To simulate the effect of embedding resonator cavities in the blade, after the blade loads were predicted using OpenCOPTER, they were filtered in accordance with the acoustic impedance of the cavities. The primary underlying assumption was that the hydrodynamic surface pressures would be affected in the same manner as acoustic pressures by the resonator cavities. In order to account for the phase delay and thermo-viscous effects introduced by the resonator cavities, the predicted blade loads were convolved with the reflection coefficient in the frequency domain. The reflection coefficient represents the ratio of the reflected to the incident acoustic pressure and can be expressed in terms of the specific acoustic impedance as given by Equation (1), where the superscripts − and + represent the reflected and incident acoustic pressures, respectively. The impedance of the cavities is normalized by the impedance of air (pao).

$$R = \frac{{p}^{-}}{{p}^{+}} = \frac{ζ - 1}{ζ + 1} \qquad ( 1 )$$

$$ζ ( ω ) = θ + j \qquad ( 2 )$$

As indicated by Equation (2), the acoustic impedance is a complex quantity that varies with frequency. The real component of impedance is known as resistance and accounts for the thermo-viscous losses within the cavity as well as the radiation loading due to the interaction of the acoustic waves within the resonator and the external environment. The imaginary or reactive component of impedance represents the natural modes of vibration of the air column within the cavity and is strictly a function of the resonator geometry.

The semi-analytical Zwikker-Kosten Transmission Line (ZKTL) model is employed to compute the normal acoustic impedance of the resonator. This model is a low-frequency approximation of the full Kirchhoff solution to the equation governing the propagation of sound waves in gas-filled cylindrical tubes. Therefore, it is valid when ka<1, where k is the free-space wavenumber and a is the radius of the cavity inlet.

For the purposes of this example, an impedance patch is defined as a region with a finite area that consists of the multiple resonator cavities. If these cavities have the same lengths, the patch is considered to have a single degree-of-freedom (SDOF). The patch will have multi-degree-of-freedom (MDOF) if it is comprised of resonator cavities with variable depths. The total average or “smeared” normal acoustic impedance of one of these patches can be computed using Equation (3). Where σᵢ is the open area ratio which is the ratio of the inlet area of the i'th resonator to the total surface area of the patch, N is the total number of resonators comprising the patch, and βᵢ is the acoustic admittance of the i'th resonator, which is the reciprocal of acoustic impedance.

$${ζ}_{avg} = {( {\sum }_{i = 1}^{N} {σ}_{i} {β}_{i} )}^{- 1} \qquad ( 3 )$$

It should be noted that the impedance of a facesheet can also be modeled using similar impedance models. However, for simplicity, the contributions of the facesheet are omitted from this analysis. It is thought that as long as the facesheet remains effectively transparent to the BVI surface pressure fluctuations, it will primarily contribute to the resistive component of impedance, which would reduce the magnitude of the blade load fluctuations. This analysis also excludes the effects of radiation loading since it is highly dependent on the application and is not known a priori for the complex aerodynamic environment considered in this example.

### Resonator Cavity Geometry and Spanwise Distribution Optimization

Since the optimal geometry and spanwise distribution of the resonator cavities is not known from first principals, a global optimization was performed using the computational framework described previously. The differential evolution global optimization algorithm (implemented in SciPy) was chosen for this application because it is a derivative free method that can explore a large portion of the design space.

The objective function is given by Equation (4). The first term in this equation is the ratio of the mean-square pressure at the location of the maximum BVI SPL in the baseline case. As evidenced by FIG. 3, the location of maximum BVI SPL occurs at (x/R=1, y/R=0.67). The mean-square pressure in Equation (4) is also filtered such that only the contributions between the 6th and 40th BPF harmonics are retained. As long as the impedance patches do not have any adverse effects on the noise emissions, the value of this term should range from zero to one and is minimized over the course of the optimization procedure.

$$f ( x ) = \frac{\overline{{p}^{2}}}{\overline{{p}_{0}^{2}}} + \frac{η}{2} {max ( 0 , - ( {V}_{o} - {\sum }_{i = 1}^{N} {A}_{i} {L}_{i} ) )}^{2} + \frac{η}{2} {max ( 0 , - ( 0.25 - \frac{{a}_{i}}{{L}_{i}} ) )}^{2} \qquad ( 4 )$$

The exterior penalty method is employed to enforce the constraints, which are represented by the two remaining terms of Equation (4). The two constraints are inequality constraints; therefore, these terms are equated to zero unless the constraints are violated in which case the value of the objective function will increase. The sensitivity of the objective function to constraint violations is controlled by the constraint parameter, η. The second term in Equation (5) represents a constraint on the total volume of all the resonators, which must be less than or equal to that of the rotor blade. The last term restricts the radius of each resonator cavity from being greater than 20% of its length.

Essentially three different optimizations were performed. The first assessed the effect of varying the resonator geometries comprising the MDOF impedance patch. The next determined the optimal spanwise distribution of SDOF patches. The third optimized the resonator geometry and spanwise distribution simultaneously. The design variables, x, differed for each of these optimizations accordingly, with the exception of the first two variables, which represent the radius and length of the reference resonator.

For the case where only the resonator geometry of the MDOF impedance patch was varied, the acoustic treatment was applied uniformly across the outer half of the blade span. It was ensured that the total open area of all the resonator cavities, comprising a single impedance patch, does not exceed the area corresponding to a quarter of the blade planform. The open area ratio, σ of 0.6 was also kept constant for each impedance patch.

To minimize the number of design variables, instead of explicitly defining the dimensions of each resonator comprising the impedance patch, Bernstein polynomials were employed as shape functions that parameterized the distribution of unique resonators geometries. Bernstein polynomials have certain properties that make them well suited for this sort of application. For instance, the basis functions of these polynomials are non-negative and their minimum and maximum values are directly related to the values of the coefficients for x∈[0, 1]. The 2nd order Bernstein polynomial, expressed by Equation (5), served as a scaling factor for the length and radius of the reference resonator cavity. The coefficients of the first two basis functions, βₒ and β₁ are the other design variables, while β₂ is set equal to unity. A single impedance patch is set to consist of ten unique resonator geometries.

B(x)=B₀(1−x)²+B₁x(1−x)+B₂x² (5)

The 2nd order Bernstein polynomials were also used to prescribe the spanwise distribution of the SDOF patches. The polynomials essentially represent the instantaneous frequency of a square wave, whose amplitude varies from zero to unity. The blade loads at a particular spanwise location are filtered if the amplitude of the square wave is one, otherwise, they remain unaffected. In this case, all three coefficients of the Bernstein polynomial are the design variables. This results in a total of seven design variables when the resonator geometry and their spanwise distribution are optimized simultaneously.

### Results—Geometry Variations

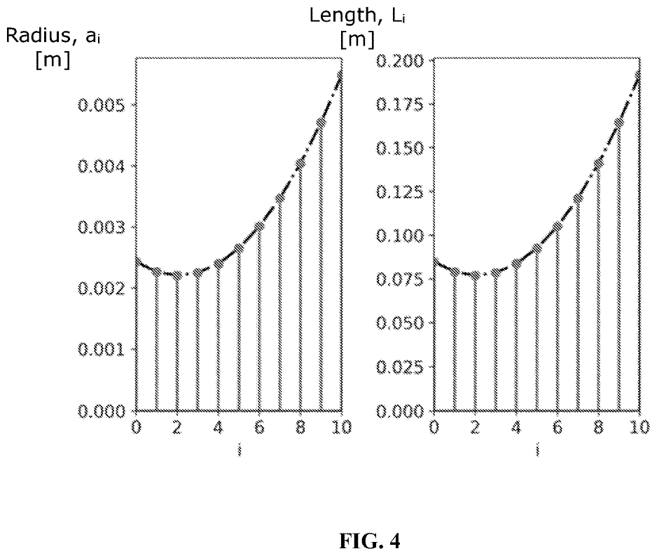

As described above, the blade loads are filtered in accordance with the average acoustic impedance of each impedance patch. FIG. 4 displays the optimal resonator geometry distribution comprising each MDOF impedance patch. Each patch is assumed to be composed of ten unique resonator geometries. In this case the radius and length of the reference resonator are 6 mm and 200 mm, respectively. The dimensions of the other resonators of the MDOF patch are determined by scaling these reference dimensions by the Bernstein polynomial weighting function.

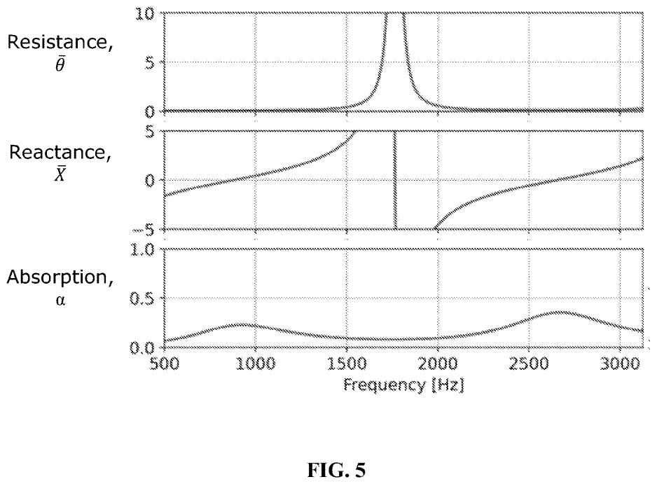

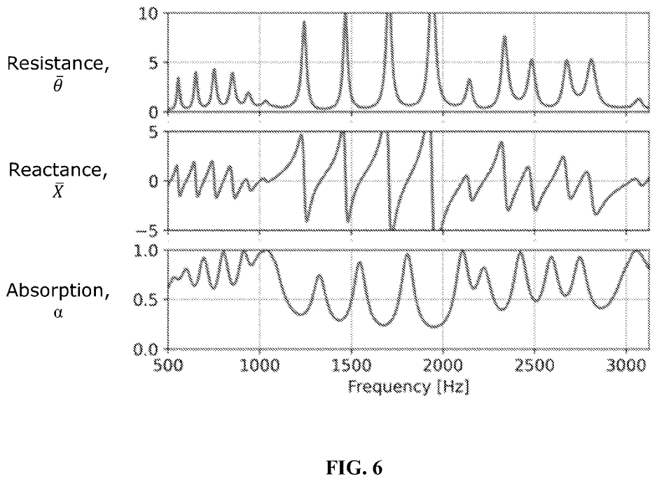

The resistive and reactance components of the normal acoustic impedance for the SDOF and MDOF impedance patches are presented in FIGS. 5 and 6, along with the corresponding acoustic absorption coefficient. The majority of acoustic energy is absorbed at resonance when the value of absorption coefficient is near unity. This occurs at frequencies where the resistance and reactance are both close to zero. The SDOF patch has two absorption peaks at ≈850 Hz and ≈2550 Hz, which correspond to the natural frequencies for an open-closed cavity with a length of ≈0.1 m. The MDOF impedance patch has a more complex acoustic response with multiple peaks in the absorption coefficient, which correspond to the natural frequencies of each resonator comprising the patch.

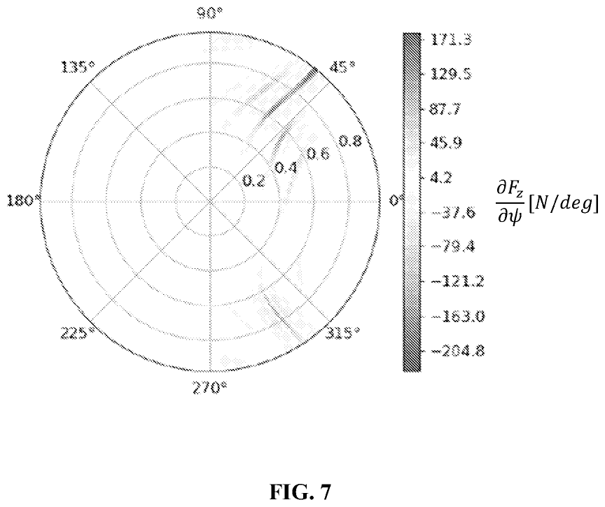

Since the acoustic emissions are a direct consequence of the time rate of change in the blade loads, it is instructive to examine the variation in this quantity azimuthally about the rotor disk. Therefore, the polar plot in FIGS. 7-9 display a top-down view of the time rate of change in the lift component of the blade loads for the baseline as well as the two treated cases. In FIGS. 7-9, the nose of the vehicle is oriented towards 180° and the rotor is rotating counterclockwise.

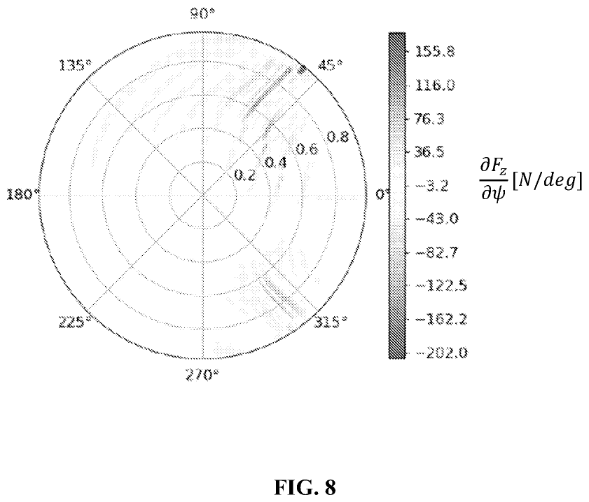

In FIG. 7, the rapid fluctuations in the blade loads that are indicative of BVI are evident on the rear half and on the advancing and retreating sides of the rotor disk. As shown FIG. 8, filtering the blade loads with the reflection coefficient of the SDOF impedance patches, results in a phase shift and a reduction in the magnitude of these fluctuations along the treated region. The phase shift is believed to be introduced by the time it takes the pressure pulse associated with each BVI event to propagate into and out of the resonator cavities. While the amplitude reduction is attributed to the viscous and thermal energy dissipation effects within the cavities. It should be noted that the last several blade elements near the blade tip are not filtered because the total open area of the resonator cavities exceeds that of the impedance patch.

Filtering the blade loads with the response of the MDOF impedance patch significantly reduces the magnitude of these fluctuations and further distributes their energy azimuthally about the rotor disk. This is likely attributed to the complex frequency response of this patch, as shown in FIG. 6. Considering that the blade loads differ at each spanwise blade section, the filtering process likely affects each one differently and introduces varying amounts of time delay. This is thought to effectively alter the kinematics associated with BVI noise, which prevents the acoustic waves from coalescing.

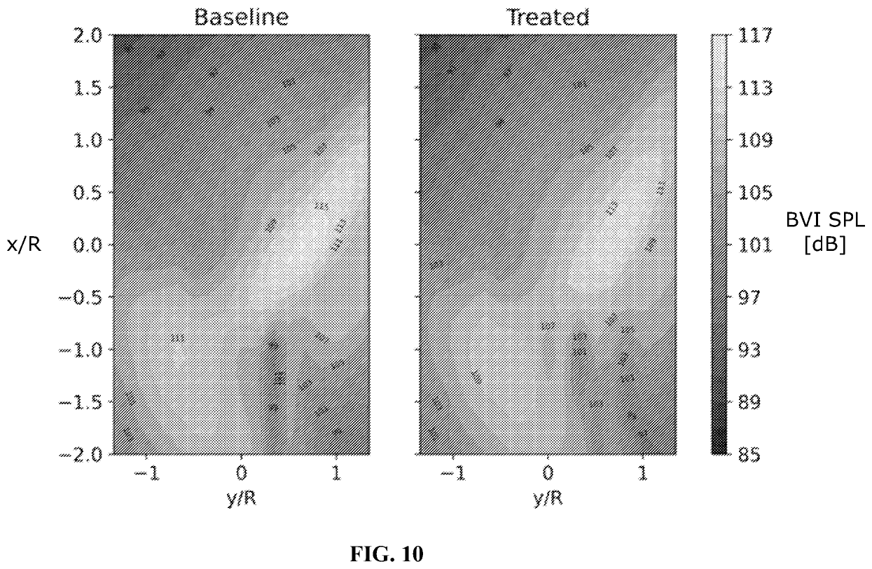

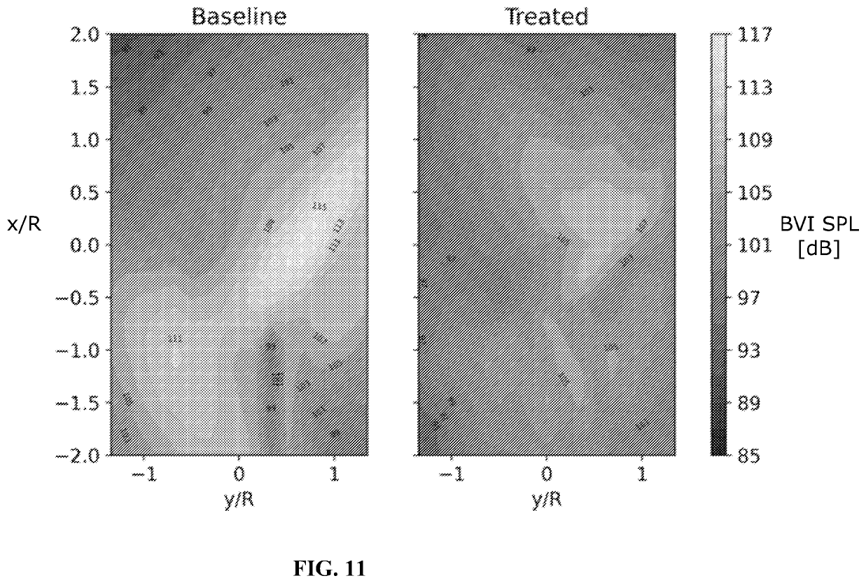

A comparison between the predicted acoustic emissions corresponding to the baseline rotor blades and those treated with SDOF and MDOF impedance patches are presented in FIGS. 10 and 11, respectively. Uniformly applying the SDOF impedance patches to the outer 50% of the blade span results in ≈2 dB reduction in the BVI SPL in the two regions where it is maximum, underneath the advancing and retreating sides of the rotor disk. The BVI noise directivity pattern remains largely unaltered from the baseline case. This suggests that the attenuation resulting from the SDOF patches is primarily due to the dissipative losses within the cavities. The acoustic focusing is likely unaffected by the uniformly distributed SDOF patches since they shift the blade load fluctuations uniformly to a slightly different azimuthal location, as shown in FIG. 8.

However, as shown in FIG. 11, the MDOF impedance patches are predicted to reduce the BVI SPL in these two regions by ≈8 dB. The corresponding directivity pattern also differs greatly from the baseline case. This suggests that by significantly changing the magnitude and distribution of the blade load fluctuations, this treatment alters the kinematics of BVI noise and prevents the corresponding acoustic wavefronts from coalescing.

### Results—Spanwise Distribution Variations

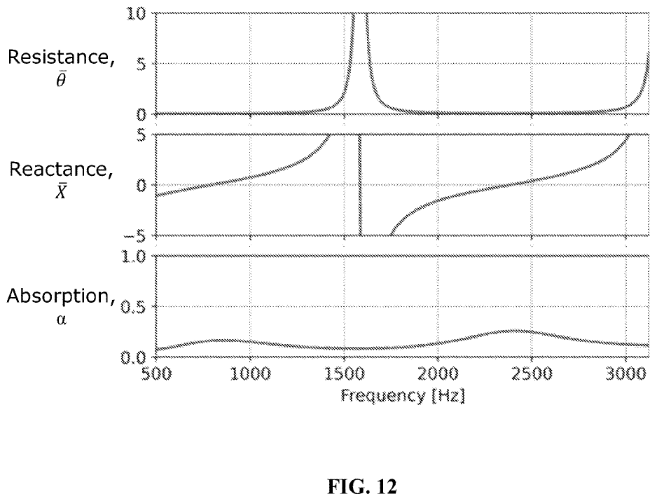

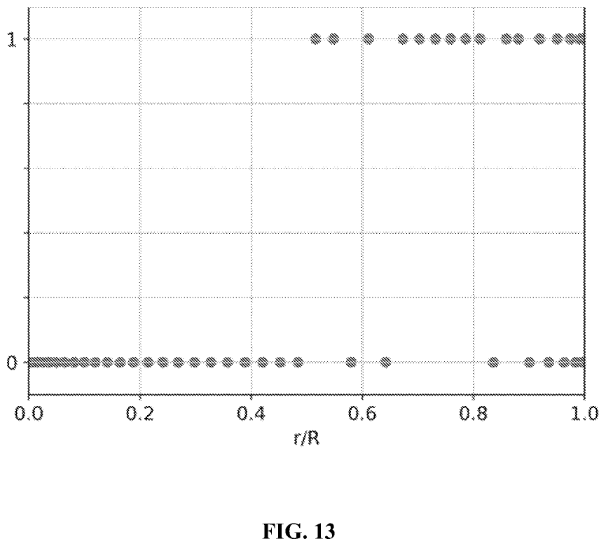

Since the effectiveness of this BVI noise reduction strategy is dependent on dephasing the acoustic wavefronts generated by BVI, it is postulated that favorable results can be achieved by applying these impedance patches to specific spanwise blade sections (e.g. lengthwise blade sections of the blade 102). In this case, SDOF impedance patches can be applied to the blade. Each patch is comprised of resonator cavities that have a radius and length of 3 mm and 106 mm, respectively, for the results of the evaluation shown in FIG. 12. This resonator geometry yielded the frequency response shown in FIG. 12 for this particular evaluation of an exemplary embodiment. The optimal spanwise distribution of these resonators is displayed in FIG. 13. The blade loads are filtered at the spanwise locations corresponding to a value of one in FIG. 13. Note that the blade elements assume a cosine spacing, which is necessitated by the circulation model employed in OpenCOPTER.

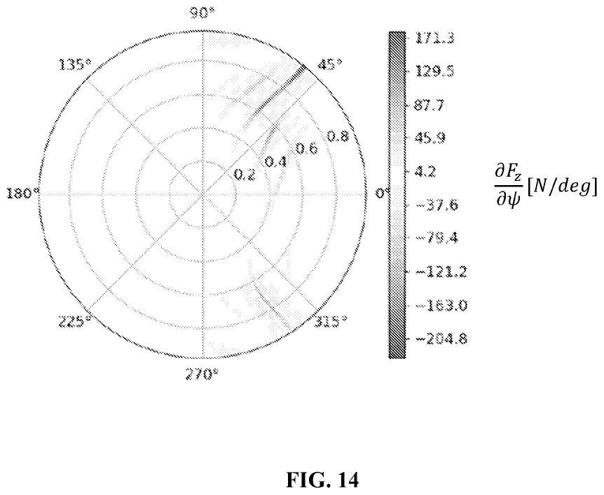

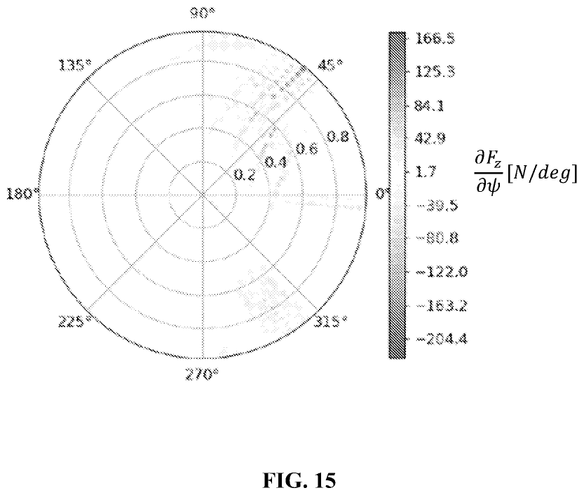

FIGS. 14-15 presents a comparison of the time rate of change in lift generated by the baseline and treated blades. As anticipated, the optimal spanwise resonator distribution introduces a phase shift along the treated sections of the blade. This is what gives the fluctuations in the blade loads the staggered appearance in FIG. 15. The magnitudes of the load fluctuations at the filtered blade sections are also reduced due to the energy dissipation effects within the resonator cavities.

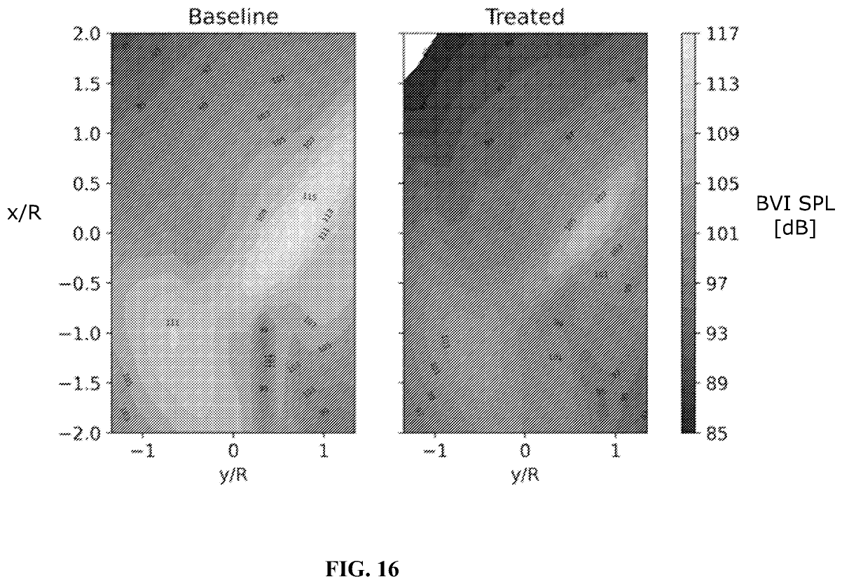

The corresponding predicted acoustic emissions are shown in FIG. 16. Evidently, varying the spanwise distribution of the SDOF patches greatly improves their effectiveness in comparison to when they were applied uniformly across the outer portion of the blade span. This also results in an attenuation of BVI noise by ≈8 dB in the two hotspots beneath the advancing and retreating sides of the rotor disk. Interestingly, the treatment has a minimal effect on the directivity of BVI noise, which suggests that the wavefronts of the BVI sources still coalesce but perhaps to a lesser degree than in the baseline case. This is actually a very encouraging finding since it shows that this noise reduction technique can be effective with fewer resonator cavities. This would reduce the complexity associated with fabricating these resonators and also the corresponding viscous drag penalty introduced by their installation.

### Results—Geometry and Spanwise Distribution Variations

The natural next question is whether combining the effects of varying the spanwise distribution of MDOF impedance patches would further attenuate BVI noise. In this case, the optimal resonator geometry distribution of a single impedance patch, shown in FIG. 4, was applied to only the blade sections designated in FIG. 13.

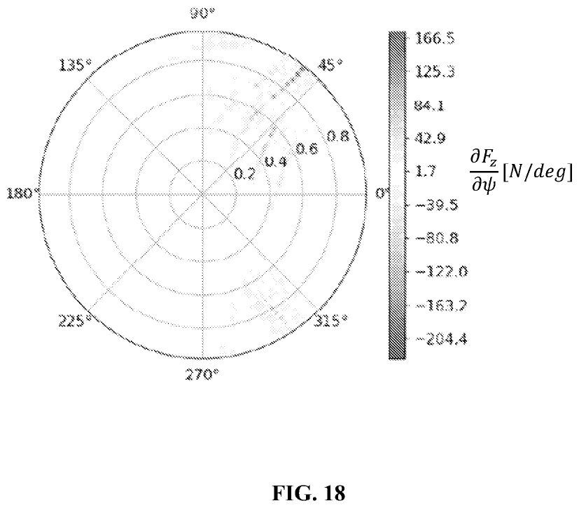

The corresponding time rate of change of the blade loads is shown in FIG. 18 and exhibits similar features to that shown in FIG. 15. However, the magnitude of the phase shifted load fluctuations is reduced due to the complex frequency response of the MDOF impedance patches, as shown in FIG. 6.

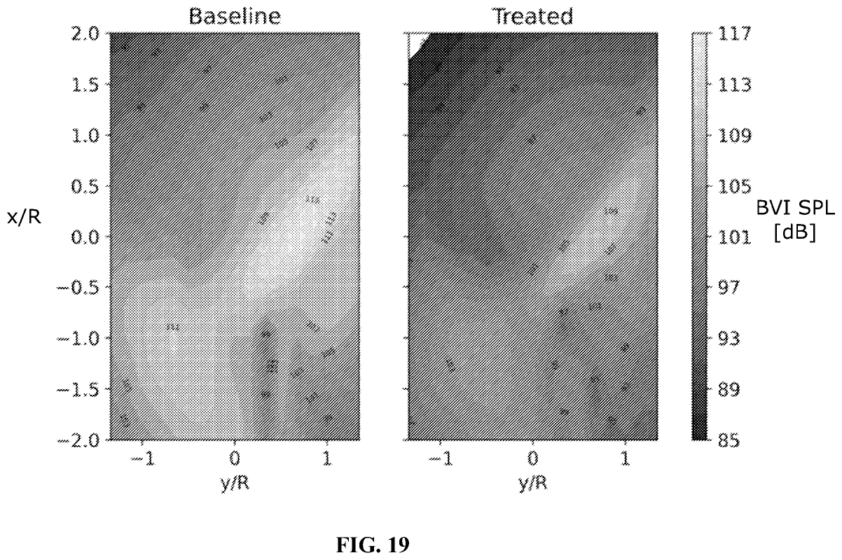

FIG. 19 presents the corresponding predicted noise emissions. The noise levels are attenuated by ≈6 dB in the two regions of maximum BVI SPL in comparison to the baseline case. Interestingly, the levels are higher in comparison to when the geometry of the MDOF patches and the spanwise distribution of SDOF patches were varied separately. This suggests that even though the underlying physics are consistent, BVI noise is attenuated through different means with these two approaches.

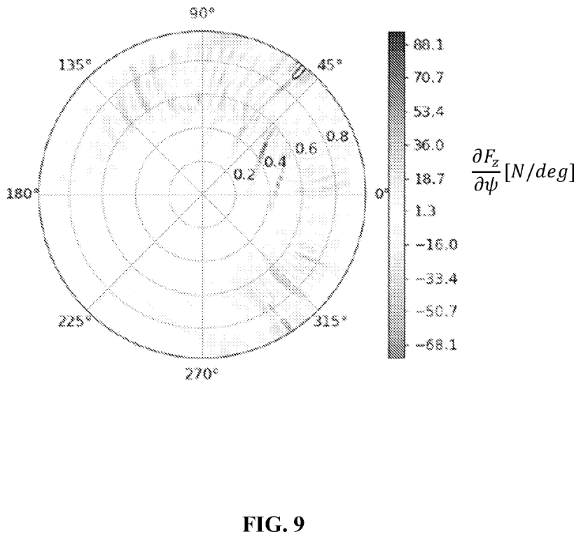

As evidenced by FIG. 9, applying the MDOF impedance patch to the blade azimuthally distributes the energy associated with the rapid fluctuations in the blade loads. While varying the spanwise distribution of SDOF impedance patches is thought to introduce precisely the right amount of phase delay to effectively disrupt the off-body acoustic phase accumulation process.

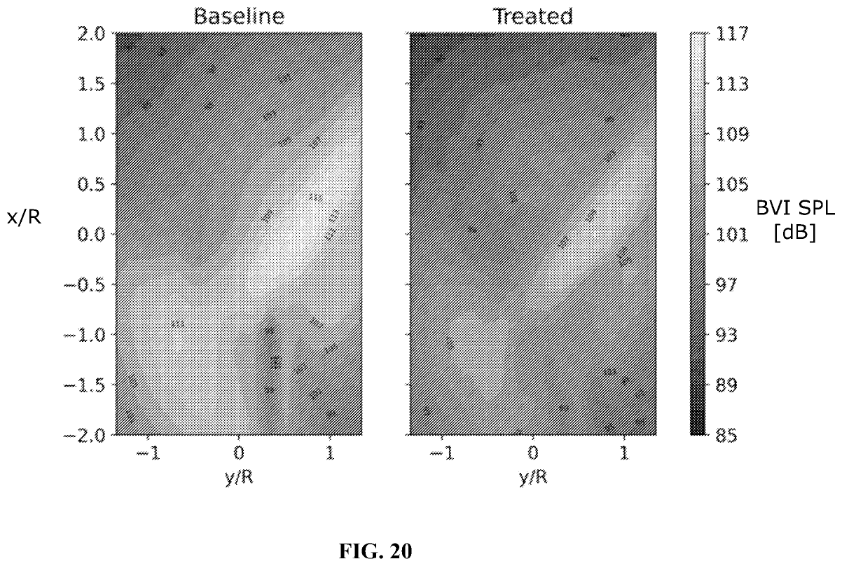

The geometry and spatial distribution of the impedance patches were also optimized simultaneously. The corresponding predicted acoustic emissions are presented in FIG. 20. The noise emissions are quite similar to those shown in FIG. 19 in terms of the BVI SPL and directivity pattern. This further supports the claim that the benefits of varying the geometry and spatial distribution of the impedance patches does not necessarily compound because the manner in which they “diphase” the acoustic wavefronts generated by the BVIs differs.

Embodiments of our rotor blade 102 can be included for use in different rotorcraft. In so doing, a process of rotating a rotor having one or more blades 102 can be provided that can result in reduced noise levels. For example, in a first step, one or more blades 102 can be provided that include a plurality of resonator cavities 108. The cavities 108 can have a uniform length or can include a number of different length dimensioned cavities that are spatially positioned to meet a pre-selected set of noise reduction criteria and other design criteria. One or more of the blades 102 can be installed for rotation to facilitate motion of a vehicle (e.g. flight of a helicopter, flight of a drone or plane, movement of a submarine, etc.). Fluid (e.g. air or water) can be passed through the resonator cavities 108 as the blade(s) 102 are rotated to drive motion of a vehicle. The resonator cavities 108 provide an alternate path for surface pressure fluctuations to travel through. This introduces a phase shift that prevents the acoustic wavefronts from coalescing, which provides an overall reduction in noise associated with the motion of the blade(s) 102. This noise reduction can be significant and can provide a substantial improvement in noise reduction associated with operation of a vehicle.

It should be understood that modifications to the embodiments disclosed herein can be made to meet a particular set of design criteria. For instance, the number of or configuration of components or parameters may be used to meet a particular objective.

It will be apparent to those skilled in the art that numerous modifications and variations of the described examples and embodiments are possible in light of the above teachings of the disclosure. The disclosed examples and embodiments are presented for purposes of illustration only. Other alternative embodiments may include some or all of the features of the various embodiments disclosed herein. For instance, it is contemplated that a particular feature described, either individually or as part of an embodiment, can be combined with other individually described features, or parts of other embodiments. The elements and acts of the various embodiments described herein can therefore be combined to provide further embodiments.

It is the intent to cover all such modifications and alternative embodiments as may come within the true scope of this invention, which is to be given the full breadth thereof. Additionally, the disclosure of a range of values is a disclosure of every numerical value within that range, including the end points. Thus, while certain exemplary embodiments of the apparatus and process and/or utilization and methods of making and using the same have been discussed and illustrated herein, it is to be distinctly understood that the invention is not limited thereto but may be otherwise variously embodied and practiced within the scope of the following claims.

1. A rotorcraft blade comprising:
a body, the body having a top surface, a length, a width, and a thickness,
wherein the body of the rotorcraft blade comprises a plurality of resonator cavities positioned in the top surface to extend from the top surface to within the thickness of the body;
each of the resonator cavities being sized and configured to extend from the top surface to within the body for reducing a noise caused via rotation of the at least one rotor blade.

2. The rotorcraft blade of claim 1, wherein a distal region of the rotor blade comprises a first grouping of the resonator cavities as a first patch of the resonator cavities.

3. The rotorcraft blade of claim 2, wherein a proximal region of the rotor blade comprises a second grouping of the resonator cavities as a second patch of the resonator cavities.

4. The rotorcraft blade of claim 1, wherein the plurality of cavities are configured to attenuate blade vortex interaction noise by at least 6 decibels.

5. The rotorcraft blade of claim 1, wherein each cavity has a radius and a length, wherein the radius is less than a shortest acoustic wavelength of interest.

6. The rotorcraft blade of claim 1, wherein at least one of the resonator cavities is bent such that the cavity extends in a width direction of the rotor blade within a thickness of the rotor blade.

7. The rotorcraft blade of claim 1, wherein the resonator cavities are arranged in spaced apart patches of resonator cavities along the length of the blade.

8. The rotorcraft blade of claim 1, further comprising:
a facesheet covering the resonator cavities.

9. The rotorcraft blade of claim 1, wherein the resonator cavities have different lengths or have uniform lengths.

10. The rotorcraft blade of claim 1, wherein some of the resonator cavities have different lengths.

11. The rotorcraft blade of claim 10, wherein the resonator cavities have between 2 and 50 unique lengths.

12. The rotorcraft blade of claim 1, wherein the resonator cavities are distributed in one or more patches positioned at an outermost 25% of the rotor blade adjacent to a leading edge of the body.

13. The rotorcraft blade of claim 12, wherein the outermost 25% of the rotor blade has an open area ratio of 0.6.

14. The rotorcraft blade of claim 1, wherein the resonator cavities are configured to attenuate blade vortex interaction noise by at least 8 decibels.

15. The rotorcraft blade of claim 1, wherein each of the resonator cavities has a radius and a length, and wherein at least some of the resonator cavities are bent to extend within the body along a portion of the width of the body.

16. A rotorcraft comprising:
a rotatable hub connected to at least one rotorcraft blade of claim 1.

17. A process for reducing noise associated with rotation of one or more rotor blades, the process comprising:
providing one or more blades, each blade having a plurality of resonator cavities; and
rotating the one or more blades to cause a device to move such that fluid is passed through the resonator cavities during rotation of the one or more blades, the fluid being passed through the resonator cavities to provide at least one phase shift of sound to reduce noise generated via rotation of the one or more blades.

18. The process of claim 17, wherein the device is a helicopter or a drone.

19. The process of claim 17, comprising:
defining the resonator cavities in the blade to extend from a top surface of the blade to within a thickness of the blade.

20. The process of claim 19, wherein the resonator cavities are defined to have a uniform length, or
wherein the resonator cavities are defined so at least some of the resonator cavities have different lengths.

21. (canceled)
